(19) United States
(12) Patent Application Publication
(10) Pub. No.: US 2016/0185680 A1
(43) Pub. Date: Jun. 30, 2016

(54) STABLE INSECTICIDAL PREMIXTURE FORMULATIONS

(71) Applicant: Valent U.S.A. Corporation, Walnut Creek, CA (US)

(72) Inventor: Bhaskar M. Ramachandran, Mountain House, CA (US)

(21) Appl. No.: 14/983,777

(22) Filed: Dec. 30, 2015

Related U.S. Application Data
(60) Provisional application No. 62/098,897, filed on Dec. 31, 2014.

(51) Int. Cl. C05G 3/02; C05B 17/00; A01N 25/10; C05G 3/00; A01N 43/78; A01N 53/00

(52) U.S. Cl. CPC C05G 3/02; A01N 43/78; A01N 53/00; A01N 25/10; C05G 3/0064; C05B 17/00

(57) ABSTRACT

The present invention generally relates to agricultural formulations comprising at least one insecticide selected from the group consisting of pyrethroids and neonicotinoids, and at least one polymeric dispersant selected from the group consisting of anionic polyacrylate carboxylate copolymers, anionic styrene acrylic acid copolymers, and polyvinyl pyrrolidone copolymers.

### FIELD OF THE INVENTION

The present invention is generally directed to storage stable agricultural formulations comprising at least one insecticide selected from the group consisting of a pyrethroid and a neonicotinoid, and at least one polymeric dispersant selected from the group consisting of an anionic polyacrylate carboxylate copolymer, an anionic styrene acrylic acid copolymer, and a polyvinyl pyrrolidone.

### BACKGROUND OF THE INVENTION

Plant growers continually strive to produce healthy plants. The health of crop plants is especially critical because the health of the plants directly impacts yield. Crop plant growers routinely apply liquid fertilizers to the area where the plants are growing or will grow (these areas will be referred to as “the field”) in order to produce healthier plants.

Crop plant growers also often apply insecticides to the field. Two especially effective classes of insecticides are pyrethroids and neonicotinoids. Pyrethroids work by preventing the closure of sodium channels in insect membranes. Neonicotinoids work by binding to nicotinic acetylcholine receptors in insect cells causing paralysis, and then death.

Each application of an agricultural product to the field requires use of large equipment, transportation of the equipment, and skilled workers to operate the equipment. It is preferable to crop growers to apply as many products at one time as possible in order to minimize the use of these expensive resources.

In the past, it was very difficult to formulate insecticidal premixes that would be compatible with liquid fertilizers. Recently, a product was developed by FMC Corporation that allows insecticides to be applied with liquid fertilizers (see U.S. Pat. No. 8,263,527). However, when an insecticidal premix and liquid fertilizers are mixed, an unsatisfactory residue may be produced. This residue may lead to clogging of sprayers and will not allow the product to be effectively dispersed in the field.

Accordingly, there is a need for an improved formulation that allows crop growers to apply insecticides and fertilizers at the same time. This improved formulation should produce very little to no residues, and should be non-phytotoxic, storage stable, and highly effective.

### SUMMARY OF THE INVENTION

In one aspect, the present invention is directed to agricultural formulations comprising at least one insecticide selected from the group consisting of pyrethroids and neonicotinoids, and at least one polymeric dispersant selected from the group consisting of anionic polyacrylate carboxylate copolymers, anionic styrene acrylic acid copolymers, and polyvinyl pyrrolidone copolymers.

In another aspect, the present invention is directed to agricultural formulations comprising at least one insecticide selected from the group consisting of pyrethroids and neonicotinoids; at least one polymeric dispersant selected from the group consisting of anionic polyacrylate carboxylate copolymers, anionic styrene acrylic acid copolymers, and polyvinyl pyrrolidone copolymers; and at least one liquid fertilizer.

In a further aspect, the present invention is directed to methods of using the agricultural formulations of the present invention by mixing them with liquid fertilizers and applying them to crop growing areas.

### DETAILED DESCRIPTION OF THE INVENTION

Applicants unexpectedly discovered that anionic polyacrylate carboxylate copolymers, anionic styrene acrylic acid copolymers, polyvinyl pyrrolidone copolymers, or a combination thereof, allowed for neonicotinoids and pyrethroids to be mixed with liquid fertilizers. These polymeric dispersants provide stable formulations that produce very little or no residue when mixed with liquid fertilizers. This finding was especially unexpected due to the well known difficulty of formulating insecticide premixtures that are compatible with liquid fertilizers. Applicants also did not expect that these specific dispersants would require considerably less (up to 5 to 10 wt. %) dispersant to be used than prior art formulations.

“Anionic polyacrylate carboxylate copolymers” refers to a group of polymers which are based on acrylate monomers with a vinyl group and a carboxylic acid terminus neutralized as a sodium salt. Examples of suitable anionic copolymer dispersants include Agrilan® 789 dispersant (an hydrophobically modified copolymer available from AkzoNobel Agrochemicals, Agrilan is a registered trademark of Akzo Nobel Chemicals International), Agrilan® 700 dispersant (also available from AkzoNobel Agrochemicals), and Sokalan® acrylic polymers (available from BASF, Sokolan is a registered trademark of BASF Aktiengesellschaft).

“Anionic styrene acrylic acid copolymers” refers to a group of sodium neutralized styrene acrylic acid copolymers. Examples of suitable anionic copolymer dispersants include Tersperse® 2700 (which is a styrene methacrylic acid STYMA based disperant available from Huntsman Corporation, Tersperse is a registered trademark of Huntsman Petrochemical Corporation) and Atlox Metasperse™ 550 S (available from CRODA).

“Polyvinyl pyrrolidone copolymers” refers to a group of polymers which are linear, non-ionic polymers which have good solubility in many organic solvents and water. Examples of suitable polyvinyl pyrrolidone copolymers include EasySperse™ P-20 spray-dried, optimized composite polyvinyl pyrrolidone and methyl vinyl ether/maleic acid half ester dispersant (available from Ashland), Agrimer® polymers (available from Ashland, Agrimer is a registered trademark of ISP Investments Inc.) and Luvitec™ polymers (available from BASF).

In one embodiment, the present invention is directed to agricultural formulations comprising at least one insecticide selected from the group consisting of pyrethroids and neonicotinoids, and at least one polymeric dispersant selected from the group consisting of anionic polyacrylate carboxylate copolymers, anionic styrene acrylic acid copolymers, and polyvinyl pyrrolidone copolymers.

In another preferred embodiment, the formulations of the present invention include at least one neonicotinoid that is selected from the group consisting of clothianidin, imidacloprid, thiamethoxam, dinotefuran, nitenpyram, and thiacloprid. In a more preferred embodiment, the neonicotinoid is clothianidin.

In a further embodiment, the formulation contain at least one pyrethroid that is selected from the group consisting of bifenthrin, zeta-cypermethrin, beta-cypermethrin, cypermethrin, deltamethrin, permethrin, lambda-cyhalothrin, gamma-cyhalothrin, tralomethrin, cyfluthrin, beta-cyfluthrin, esfenvalerate, fluvalinate, and natural pyrethrum. In a preferred embodiment, the pyrethroid is bifenthrin. In a most preferred embodiment, the formulations contain clothianidin and bifenthrin.

In another embodiment, the formulations contain from about 5 to about 20% w/w of neonicotinoid. Preferably, the formulations contain from about 7 to about 18% w/w of neonicotinoid. More preferably, the formulations contain from about 9 to about 16% w/w of neonicotinoid. Most preferably, the formulations contain from about 12 to about 14% w/w of neonicotinoid.

In another embodiment, the formulations contain from about 5 to about 20% w/w of clothianidin. Preferably, the formulations contain from about 7 to about 18% w/w of clothianidin. More preferably, the formulations contain from about 9 to about 16% w/w of clothianidin. Most preferably, the formulations contain from about 12 to about 14% w/w of clothianidin.

In another embodiment, the formulations contain from about 1 to about 15 w/w of pyrethroid. Preferably, the formulations contain from about 3 to about 12% w/w of pyrethroid. More preferably, the formulations contain from about 5 to about 10% w/w of pyrethroid. Most preferably, the formulations contain from about 6 to about 8% w/w of pyrethroid.

In another embodiment, the formulations contain from about 1 to about 15% w/w of bifenthrin. Preferably, the formulations contain from about 3 to about 12% w/w of bifenthrin. More preferably, the formulations contain from about 5 to about 10% w/w of bifenthrin. Most preferably, the formulations contain from about 6 to about 8% w/w of bifenthrin.

In yet another embodiment, the anionic polyacrylate is a hydrophobically modified polyacrylate. As used herein, “hydrophobically modified” means that the polyacrylate possesses hydrophobic groups grafted into its backbone either at the ends or in a comb like fashion.

In a preferred embodiment, the polymeric dispersant is from about 1 to about 10% w/w of the formulation. Preferably, the formulations contain from about 2 to about 8% w/w of polymeric dispersant. More preferably, the formulations contain from about 3 to about 7% w/w of polymeric dispersant. Most preferably, the formulations contain from about 4 to about 7% w/w of polymeric dispersant.

In a preferred embodiment, the hydrophobically modified polyacrylate is from about 1 to about 10% w/w of the formulation. Preferably, the formulations contain from about 2 to about 8% w/w of the hydrophobically modified polyacrylate. More preferably, the formulations contain from about 3 to about 7% w/w of the hydrophobically modified polyacrylate. Most preferably, the formulations contain from about 4 to about 7% w/w of the hydrophobically modified polyacrylate.

In another embodiment, the formulations exclude the following dispersants: sucrose esters, lignosulfonates, alkylpolyglycosides, naphthalene-sulfonic acid formaldehyde condensates, and phosphate esters.

In yet another embodiment, the formulations include at least one stabilizer. In a preferred embodiment, the stabilizer is selected from the group consisting of magnesium aluminum silicate and mixtures of silica and metal oxides.

If the formulations comprise a stabilizer, the formulations comprise from about 0.1 to about 2% w/w of the stabilizer. Preferably, the formulations comprise from about 0.1 to about 1% w/w of the stabilizer.

In another embodiment, the formulations comprise glycerol. In a preferred embodiment, the formulations comprise from about 1 to about 25% w/w of glycerol. In a more preferred embodiment, the formulations comprise from about 5 to about 20% w/w of glycerol. In a most preferred embodiment, the formulations comprise from about 10 to about 18% w/w of glycerol.

In an embodiment, the formulations include an anti-foaming agent. In a preferred embodiment, the anti-foaming agent is a silicone based compound. For example, proprietary silicone based anti-foaming agents such as Antifoam FG10 (available from Dow Corning Corporation) and Xiameter® AFE 0010 (available from Dow Corning Corporation, Xiameter is a registered trademark of Dow Corning Corporation) can be used in the formulations.

If the formulations include an anti-foaming agent, the formulation comprise from about 0.1 to about 2% w/w of the anti-foaming agent. In a preferred embodiment, the formulations comprise from about 0.1 to about 0.5% w/w of the anti-foaming agent.

In another embodiment, the formulations include a preservative. In a preferred embodiment, the preservative is a biocide. In a more preferred embodiment, the biocide is a 20% aqueous dipropylene glycol solution of 1,2-benzisothiazolin-3-one.

If the formulations include a preservative, the formulations comprise from about 0.01 to about 1% w/w of the preservative. In a preferred embodiment, the formulations comprise from about 0.01 to about 0.3% w/w of the preservative.

In yet another embodiment, the formulations include a wetting agent. In a preferred embodiment, the wetting agent is a sodium dioctylsulfosuccinate wetting agent.

If the formulations include a wetting agent, the formulations comprise from about 0.01 to about 1% w/w of the wetting agent. In a preferred embodiment, the formulations comprise from about 0.02 to about 0.08% w/w of the wetting agent.

In an embodiment, the formulations include phosphoric acid. In a preferred embodiment, the formulations comprise from about 0.01 to about 1% w/w of the phosphoric acid. In a more preferred embodiment, the formulations comprise from about 0.05 to about 0.25% w/w of the phosphoric acid.

In a further embodiment, the formulations include a surfactant. In a preferred embodiment, the surfactant is selected from the group consisting of polyoxypropylene-polyoxyethylene block copolymers and sodium alpha olefin sulfonates.

If the formulations include a surfactant, the formulations comprise from about 0.1 to about 4% w/w of the surfactant. In a preferred embodiment, the formulations comprise from about 0.1 to about 2.5% of the surfactant.

In an embodiment, the formulations include a gelling agent. In a preferred embodiment, the gelling agent has dry particles that are on average from about 5 to about 15 microns in diameter. In a more preferred embodiment, the gelling agent has dry particles that are on average from about 8 to about 10 microns in diameter. For example, Attagel 350 and Attagel 50 (both available from BASF) can be used in the formulations and have average particle diameters of 9 microns.

If the formulations include a gelling agent, the formulations comprise from about 0.1 to about 5% w/w of the gelling agent. In a preferred embodiment, the formulations comprise from about 1 to about 3.5% w/w of the gelling agent.

In a further embodiment, the present invention is directed to agricultural formulations comprising at least one insecticide selected from the group consisting of pyrethroids and neonicotinoids; at least one polymeric dispersant selected from the group consisting of anionic polyacrylate carboxylate copolymers, anionic styrene acrylic acid copolymers, and polyvinyl pyrrolidone copolymers; and at least one liquid fertilizer.

In yet another embodiment, the present invention is directed to methods for protecting crop plants comprising mixing the formulation of the present invention with a liquid fertilizer and then applying the liquid fertilizer/insecticide mixture to a plant or area where a plant is intended to grow.

The nutrients in the liquid fertilizers that are mixed with formulations of the present invention may be, for example, nitrogen, phosphorous, potassium or a combination thereof.

In a preferred embodiment, the liquid fertilizer that is mixed with the formulations of the present invention contains from about 8 to about 12% nitrogen, from about 32 to about 36% phosphorous and from about 0 to about 1% potassium. In a more preferred embodiment, the liquid contains about 10% nitrogen, about 34% phosphorous and about 0% potassium.

In another embodiment, the formulations contain from about 44 to about 56% w/w liquid fertilizer and from about 0.8 to 1.8% w/w of the insecticidal formulation.

In an alternative embodiment, the formulations contain from about 46 to 54 w/w liquid fertilizer and from about 1 to about 1.6% w/w of the insecticidal formulation.

In yet another embodiment, the formulations contain from about 48 to 52% w/w liquid fertilizer and from about 1.2 to about 1.4% w/w of the insecticidal formulation.

In a further embodiment, the insecticide/fertilizer mixture is applied where a plant is intended to grow. As used herein, “where a plant is intended to grow” refers to the soil or planting medium that a plant or seed is or may be placed into. For example, a field or growing medium in a pot is a place where a grower may intend to grow a plant.

In a preferred embodiment, the insecticide/fertilizer mixture is applied to an agricultural furrow. The furrows may be made by a plow for example. The seeds or plants could then be placed into the furrow in order to grow.

In another embodiment, the plant is selected from the group consisting of corn, wheat, soybeans, and alfalfa. In a preferred embodiment, the plants are soybeans or corn. In a more preferred embodiment, the plant is corn.

In a preferred embodiment, the present invention is directed to methods for protecting plants comprising mixing an agricultural formulation comprising at least one insecticide selected from the group consisting of pyrethroids and neonicotinoids, and at least one polymeric dispersant selected from the group consisting of anionic polyacrylate carboxylate copolymers, anionic styrene acrylic acid copolymers, and polyvinyl pyrrolidone copolymers, with a liquid fertilizer; and applying the mixture in an agricultural furrow. In a more preferred embodiment, the agricultural furrow will be planted with corn. In yet another preferred embodiment, the pyrethroid is bifenthrin and the neonicotinoid is clothianidin.

The phrase “effective amount” of the formulation means a sufficient amount of the formulation to provide the desired effect. In general, the formulation is employed in amounts that do not inhibit germination of the seeds and do not cause phytotoxic damage to the seeds or plants. The amount of the formulation may vary depending on specific crops and other factors. It is well within the ordinary skill in the art to determine the necessary amount of the formulation.

As used herein, all numerical values relating to amounts, weight percentages and the like, are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

As used herein, the “liquid fertilizer” refers a fertilizer that is not solid but in a fluid form. The liquid fertilizers may contain amounts of micronutrients as required for enhanced growth of the treated plant. Any liquid fertilizer containing either nitrogen, phosphorus, or potassium, or any combination thereof, in any ratio thereof, may be suitable for use with the formulations of the present invention. In addition, other micronutrients, such as zinc may be added. For example, the fertilizer can contain 10% nitrogen, 34% phosphorus, and 0% potassium; 6% nitrogen, 20% phosphorus, and 5% potassium; 6% nitrogen, 24% phosphorus, and 6% potassium; 7% nitrogen, 17% phosphorus, and 3% potassium; and 6% nitrogen, 0% phosphorus, 0% potassium, and 9% zinc. A liquid fertilizer containing 10% nitrogen, 34% phosphorus, and 0% potassium is especially suitable.

The disclosed embodiments are simply exemplary embodiments of the inventive concepts disclosed herein and should not be considered as limiting, unless so stated.

The following examples are intended to illustrate the present invention and to teach one of ordinary skill in the art how to make and use the invention. They are not intended to be limiting in any way.

### EXAMPLES

Agrilan® 789 dispersant was used as the source of the hydrophobically modified polyacrylate dispersant.

Tersperse® 2700 dispersant was used as the source of anionic styrene methacrylic acid (STYMA) dispersant.

EasySperse™ P-20 polymer was used as the source of a spray-dried, optimized composite polyvinyl pyrrolidone and methyl vinyl ether/maleic acid half ester dispersant.

Antifoam FG10 (available from Dow Corning Corporation) was used as the source of the silicone based anti-foam agent in Formulations 1 to 6.

Xiameter® AFE 0010 (available from Dow Corning Corporation, Xiameter is a registered trademark of Dow Corning Corporation) was used as the source of the silicone based anti-foam agent in Formulations 7 and 7A to 7C.

Proxel™ GXL (available from Lonza) was used as the source of the 20% aqueous dipropylene glycol solution of 1,2-benzisothiazolin-3-one biocide.

Attagel 350 and Attagel 50 (available from BASF) were used as the sources of the medium particle sized gelling agents.

VanGel B (available from Vanderbilt Minerals, LLC) was used as the source of magnesium aluminum silicate.

Aerosil® COK 84 (available from Evonik, Aerosil is a registered trademark of Evonik Degussa GMBH) was used as the source of the stabilizer comprising a mixture of silica and metal oxide.

Pluronic® 25R2 and Pluronic® 17R4 (both available from BASF, Pluronic is a registered trademark of BASF) were used as the sources of polyoxypropylene-polyoxyethylene block copolymer surfactants. Specifically, Formulation 7B used Pluronic® 25R2 and Formulation 7C used Pluronic® 17R4.

Surfynol 104 PG50 wetting and foam control agent (available from AirProducts) was used as the source of acetylenic diol based wetting and foam control agent.

Bio-Terge® AS 90 beads (available from Stepan, Bio-Terge is a registered trademark of Stepan Company) was used as the source of sodium alpha olefin sulfonates.

Stepwet® DOS 70 (available from Stepan, Stepwet is a registered trademark of Stepan Company) wetting agent and Geropon® SDS wetting agent (available from Rhodia, Geropon is a registered trademark of Rhodia) were used as the sources of the sodium dioctylsulfosuccinate wetting agent.

### Example 1

### Preparation of a Liquid Formulation

A formulation was prepared by combining the components listed in Table 1 below. First, a slurry was prepared by combining all of the components under high shear except the gelling agent (10%) and magnesium aluminum silicate (1%). The gelling agent and magnesium aluminum silicate were dispersed in water under high shear to make an 11% solids clay pregel. The slurry was milled using an Eiger mill to obtain an average particle size D₅₀ ˜2 um. To the recovered mill base, the clay pregel was added and mixed to make the final product which is then ready to be added to a liquid fertilizer.

TABLE 1
Formulation 1

| | % w/w of |
|---|---|
| Component | the Formulation |
| Clothianidin (98.8%) | 13.16 |
| Bifenthrin (98%) | 6.6 |
| Hydrophobically modified | 6 |
| polyacrylate dispersant | |
| Glycerol | 15 |
| Sodium alpha olefin sulfonates | 0.35 |
| Silicone based antifoam | 0.3 |
| 20% aqueous dipropylene | 0.1 |
| glycol solution of | |
| 1,2-benzisothiazolin-3-one | |
| Clay pregel | 19 |
| Water | 39.49 |

### Example 2

### Preparation of Formulation 2

A formulation was prepared by combining the components listed in Table 2 below. First, a slurry was prepared by combining all of the components under high shear except the gelling agent (10%) and magnesium aluminum silicate (1%). The gelling agent and magnesium aluminum silicate were dispersed in water under high shear to make an 11% solids clay pregel. The slurry was milled using an Eiger mill to obtain an average particle size D₅₀ ˜2 um. To the recovered mill base the clay pregel was added and mixed to make the final product which is then ready to be added to a liquid fertilizer.

TABLE 2
Formulation 2

| | % w/w of the |
|---|---|
| Component | Formulation |
| Clothianidin (98.8%) | 13.16 |
| Bifenthrin (98%) | 6.6 |
| Polystyrene dispersant | 6 |
| Glycerol | 15 |
| Sodium alpha olefin sulfonates | 0.35 |
| Silicone based antifoam | 0.3 |
| 20% aqueous dipropylene | 0.1 |
| glycol solution of | |
| 1,2-benzisothiazolin-3-one | |
| Clay pregel | 20 |
| Water | 38.49 |

### Example 3

### Preparation of Formulation 3

A formulation was prepared by combining the components listed in Table 3 below. First, a mill base slurry was prepared by combining all of the components except the gelling agent (10%). The slurry was milled to D₅₀ ˜2 um and the gelling agent was added to the mill base and it was then ready to be added to a liquid fertilizer.

TABLE 3
Formulation 3

| | % w/w of the |
|---|---|
| Component | Formulation |
| Clothianidin (98.8%) | 13.16 |
| Bifenthrin (98%) | 6.6 |
| Polystyrene dispersant | 6 |
| Glycerol | 15 |
| Acetylenic diol based | 0.1 |
| wetting/foam control agent | |
| Sodium alpha olefin sulfonates | 0.35 |
| Silicone based antifoam | 0.3 |
| 20% aqueous dipropylene | 0.1 |
| glycol solution of | |
| 1,2-benzisothiazolin-3-one | |
| Clay pregel | 20 |
| Water | 38.39 |

### Example 4

### Preparation of Formulation 4

A formulation was prepared by combining the components listed in Table 4 below. First, a mill base slurry was prepared by combining all of the components except the gelling agent (10%). The slurry was milled to D₅₀ ˜2 um and the gelling agent was added to the mill base and it was then ready to be added to a liquid fertilizer.

TABLE 4
Formulation 4

| | % w/w of the |
|---|---|
| Component | Formulation |
| Clothianidin (99.7%) | 13.1 |
| Bifenthrin (99.4%) | 6.6 |
| Hydrophobically modified | 3.0 |
| polyacrylate dispersant | |
| Polyvinyl pyrrolidone | 1.0 |
| and methyl vinyl ether/maleic | |
| acid half ester dispersant | |
| Glycerol | 15 |
| 20% aqueous dipropylene | 0.1 |
| glycol solution of | |
| 1,2-benzisothiazolin-3-one | |
| Silicone based antifoam | 0.5 |
| Sodium dioctylsulfosuccinate | 0.05 |
| wetting agent | |
| Sodium alpha olefin sulfonates (88%) | 0.05 |
| Medium particle sized gelling | 25 |
| agent (9%) and magnesium | |
| aluminum silicate (1%) | |
| Phosphoric acid (85%) | 0.2 |
| Water | 35.4 |

### Example 5

### Preparation of Formulation 5

A formulation was prepared by combining the components listed in Table 5 below. First, a mill base slurry was prepared by combining all of the components except the gelling agent (10%). The slurry was milled to D₅₀ ˜2 um and then the gelling agent was added to the mill base. The formulation was then ready to be added to a liquid fertilizer.

TABLE 5
Formulation 5

| | % w/w of the |
|---|---|
| Component | Formulation |
| Clothianidin | 17 |
| Hydrophobically | 3 |
| modified polyacrylate | |
| dispersant | |
| Polyvinyl pyrrolidone dispersant | 1 |
| Sodium dioctylsulfosuccinate | 0.6 |
| wetting agent | |
| Sodium alpha olefin sulfonates (88%) | 0.1 |
| Glycerol | 15 |
| Silicone based antifoam | 1.5 |
| Medium particle sized | 25 |
| gelling agents (9%) + magnesium | |
| aluminum silicate (1%) | |
| 20% aqueous dipropylene | 0.1 |
| glycol solution of | |
| 1,2-benziothiazolin-3-one | |
| Phosphoric acid (85%) | 0.2 |
| Water | 36.5 |
| | 100 |

### Example 6

### Preparation of Formulation 6

A formulation was prepared by combining the components listed in Table 6 below. First, a mill base slurry was prepared by combining all of the components except the gelling agent (10%) The slurry was milled to D₅₀ ˜2 um and the gelling agent was added to the mill base and it was then ready to be added to a liquid fertilizer.

TABLE 6
Formulation 6

| | % w/w of the |
|---|---|
| Component | Formulation |
| Bifenthrin | 17 |
| Hydrophobically modified | 3 |
| polyacrylate dispersant | |
| Polyvinyl pyrrolidone dispersant | 1 |
| Sodium dioctylsulfosuccinate | 0.4 |
| wetting agent | |
| Sodium alpha olefin | 0.1 |
| sulfonates (88%) | |
| Glycerol | 15 |
| Silicone based antifoam | 1.5 |
| Medium particle sized gelling | 25 |
| agents (9%) + magnesium | |
| aluminum silicate (1%) | |
| 20% aqueous dipropylene | 0.1 |
| glycol solution of | |
| 1,2-benzisothiazolin-3-one | |
| Phosphoric acid (85%) | 0.2 |
| Water | 36.7 |
| | 100 |

### Example 7

Formulations 1 to 6 of the present invention were mixed with a liquid fertilizer and then filtered through a 50 mesh sieve. The results are below in Table 7.

TABLE 7
Results of Mixing with a Liquid Fertilizer

| Formulation | Observations |
|---|---|
| Formulation 1 | Few small bubbles, easily washed away |
| Formulation 2 | Few small bubbles, easily washed away |
| Formulation 3 | Few small bubbles, easily washed away |
| Formulation 4 | No residue |
| Formulation 5 | Very little residue, washed easily with water |
| Formulation 6 | No residue |

As can be seen in Table 7, all of the formulations exhibited satisfactory qualities when mixed with a liquid fertilizer. This was unexpected because other formulations that Applicant tested formed residues that were unsatisfactory.

### Example 8

### Preparation of Formulations 7A to 7C

A formulation was prepared by combining the components listed in Table 8 below. First, a slurry was prepared by combining all of the components under high shear. The slurry was milled using an Eiger mill to obtain an average particle size D₅₀ ˜2 um.

TABLE 8
Formulation 7 Mill Base

| | % w/w of the |
|---|---|
| Component | Formulation |
| Clothianidin (99.7%) | 13.1 |
| Bifenthrin (98%) | 6.6 |
| Hydrophobically modified | 8 |
| polyacrylate dispersant | |
| Glycerol | 10 |
| Silicone based antifoam | 0.5 |
| 20% aqueous dipropylene | 0.2 |
| glycol solution of | |
| 1,2-benzisothiazolin-3-one | |
| Silica and metal oxide | 1 |
| Water | 55.4 |

The components listed in each of the columns of Table 9 below were separately mixed with the recovered mill base to make Formulations 7A, 7B and 7C. These formulations were then ready to be added to a liquid fertilizer.

TABLE 9
Formulations 7A, 7B and 7C

| | % w/w of the | | |
|---|---|---|---|
| | Formulation | | |
| Component | 7A | 7B | 7C |
| Formulation 7 | 94.8 | 94.8 | 94.8 |
| Mill Base | | | |
| Anti-foaming agent | 0.5 | 0.5 | 0.5 |
| Polyoxypropylene- | 0 | 2 | 2 |
| polyoxyethylene block | | | |
| copolymer surfactant | | | |
| Water | 4.7 | 2.7 | 2.7 |
| Total | 100 | 100 | 100 |

Applicant found that polyoxypropylene-polyoxyethylene block copolymer surfactants provided excellent stability by thickening the formulations. These surfactants are also compatible with liquid fertilizers.

Further, Applicant found that stabilizers containing a mixture of silica and metal oxides are effective stabilizers and that clay-based stabilizers (such as magnesium aluminum silicate) were not required for stability.

1. An agricultural formulation comprising:
at least one insecticide selected from the group consisting of pyrethroids and neonicotinoids; and
at least one polymeric dispersant selected from the group consisting of anionic polyacrylate carboxylate copolymers, anionic styrene acrylic acid copolymers, and polyvinyl pyrrolidone copolymers.

2. The formulation of claim 1 wherein the neonicotinoid is selected from the group consisting of clothianidin, imidacloprid, thiamethoxam, dinotefuran, nitenpyram, and thiacloprid.

3. The formulation of claim 2 wherein the neonicotinoid is clothianidin.

4. The formulation of claim 1 wherein the pyrethroid is selected from the group consisting of bifenthrin, zeta-cypermethrin, beta-cypermethrin, cypermethrin, deltamethrin, permethrin, lambda-cyhalothrin, gamma-cyhalothrin, tralomethrin, cyfluthrin, beta-cyfluthrin, esfenvalerate, fluvalinate, and natural pyrethrum.

5. The formulation of claim 4 wherein the pyrethroid is bifenthrin.

6. The formulation of claim 1 wherein the anionic polyacrylate is a hydrophobically modified polyacrylate.

7. The formulation of claim 1 wherein the polymeric dispersant is from about 1 to about 10% w/w of the formulation.

8. The formulation of claim 7 wherein the polymeric dispersant is from about 2 to about 8% w/w of the formulation.

9. An agricultural formulation comprising:
at least one insecticide selected from the group consisting of pyrethroids and neonicotinoids;
at least one polymeric dispersant selected from the group consisting of anionic polyacrylate carboxylate copolymers, anionic styrene acrylic acid copolymers, and polyvinyl pyrrolidone copolymers; and
at least one liquid fertilizer.

10. The formulation of claim 9 wherein the pyrethroid is bifenthrin, the neonicotinoid is clothianidin, and the polymeric dispersant is hydrophobically modified.

11. A method of protecting crop plants comprising:
(a) mixing the formulation of claim 1 with a liquid fertilizer; and
(b) applying the mixture of the formulation of claim 1 with the liquid fertilizer to a plant or area where a plant is intended to grow.

12. The method of claim 11 wherein the liquid fertilizer is selected from the group consisting of nitrogen, phosphorous, potassium or a combination thereof.

13. The method of claim 12 wherein the liquid fertilizer is from about 8 to about 12% nitrogen, from about 32 to about 36% phosphorous and from about 0 to about 1% potassium.

14. The method of claim 13 wherein the liquid fertilizer is about 10% nitrogen, about 34% phosphorous and about 0% potassium.

15. The method of claim 11 wherein the mixture of the formulation of claim 1 with the liquid fertilizer is applied to the area where a plant is intended to grow.

16. The method of claim 15 wherein the area where a plant is intended to grow is a furrow.

17. The method of claim 11 wherein the plant is selected from the group consisting of corn, soybeans, alfalfa, and wheat.

18. The method of claim 17 wherein the plant is soybeans or corn.

19. The method of claim 18 wherein the plant is corn.

20. A method of protecting crop plants comprising:
(a) mixing an agricultural formulation comprising at least one insecticide selected from the group consisting of pyrethroids and neonicotinoids, from about 4 to about 7% w/w of at least one polymeric dispersant selected from the group consisting of anionic polyacrylate carboxylate copolymers, anionic styrene acrylic acid copolymers, and polyvinyl pyrrolidone copolymers, with a liquid fertilizer; and
(b) applying the mixture in at least one agricultural furrow.
